(19) United States
(12) Patent Application Publication
(10) Pub. No.: US 2006/0101233 A1
(43) Pub. Date: May 11, 2006

(54) Clustered instruction level parallelism processor

(75) Inventors: Andrei Terechko, Eindhoven (NL); Orlando Miguel Pires Dos Reis Moreira, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/540,702

(22) PCT Filed: Dec. 5, 2003
(86) PCT No.: PCT/IB03/05784

§ 371 Date: Jun. 24, 2005

(30) Foreign Application Priority Data
Dec. 30, 2002 (EP) 02080589.1

(51) Int. Cl. G06F 15/00

(52) U.S. Cl. 712/11

(57) ABSTRACT

The basic idea of the invention is to provide a clustered ILP processor based on a fully-connected inter-cluster network with a non-uniform latency. A clustered Instruction Level Parallelism processor is provided. Said processor comprises a plurality of clusters (C1-C6) each comprising at least one register file (RF) and at least one functional unit (FUI), wherein said clusters (C1-C6) are fully-connected to each other; and wherein the latency of the connections between said clusters (C1-C6) depends on the distance between said clusters (C1-C6).

The invention relates to a clustered Instruction Level Parallelism processor.

One main problem in the area of Instruction Level Parallelism (ILP) processors is the scalability of register file resources. In the past, ILP architectures have been designed around centralised resources to cover for the need of a large number of registers for keeping the results of all parallel operation currently being executed. The usage of a centralised register file eases data sharing between functional units and simplifies register allocation and scheduling. However, the scalability of such a single centralised register is limited, since huge monolithic register files with a large number of ports are hard to build and limit the cycle time of the processor. In particular, adding functional units will lengthen the interconnections and exponentially increase the area and the delay of the register file due to extra register file ports. The scalability of this approach is therefore limited.

Recent developments in the areas of VLSI technologies and computer architectures suggest that a decentralised organisation might be preferable in certain areas. It is predicted that the performance of future processors will be limited by communication restrins rather than computation restrains. One solution to this problem is to portion resources and to physically distribute these resources over the processor to avoid long wires, having a negative effect on communication speed as well as on the latency. This can be achieved by clustering. Many modern microprocessors exploit Instruction Level Parallelism (ILP) in form of the Very Large Instruction Word (VLIW) concept. The clustered VLIW concept was realised in many commercial processors, like HP/STM Lx, TI TMS320C6xxx, Sun MAJC, Equator MAP-CA, BOPS ManArray etc. In a clustered processor resources, like functional units and register files are distributed over separate clusters. In particular for clustered ILP architectures each cluster comprises a set of functional units and a local register. The clusters operate in lock step under one program counter. The main idea behind clustered processors is to allocate those parts of computation, which interact frequently, on the same cluster, whereas those parts which merely communicate rarely or those communication is not critical are allocated on different clusters. However, the problem is how to handle Inter-Cluster-Communication ICC on the hardware level (wires and logic) as well as on the software level (allocating variables to registers and scheduling).

A known VLIW architecture has a full point-to-point connectivity topology, i.e. each two clusters have a dedicated wiring allowing the exchange of data On the one hand, the point-to-point ICC with a full connectivity simplifies the instruction scheduling, but on the other hand the scalability is limited due to the amount of wiring needed: N(N−1), with N being the number of clusters. Accordingly, the quadratic growth of the wiring limits the scalability to 2-10 clusters. Such an architecture may include four clusters, namely clusters A, B, C and D, which are fully connected to each other. Accordingly, there is always a dedicated direct connection present between any two clusters. The latency of a inter-cluster transfer of data is always the same for every inter-cluster connection independent of the actual distance between the clusters on the chip. The actual distance on the chip between the clusters A and C, and clusters B and D is considered to be longer than the distance between the clusters A and D, A and B, B and C, as well as C and D. Furthermore, pipeline registers are arranged between each two clusters.

Furthermore, one example of a partially connected networks for point-to-point ICC scheme, the so-called RAW architecture, is described in detail in W. Lee, R. Baruna et al. “Space-Time scheduling of Instruction-Level Parallelism on a Raw Machine”, In proceedings of the Eighth International Conference on Architectural Support for Programming Language and Operation System, San Jose, Calif., October 1998. Here, the clusters are not connected to all other clusters (fully connected) but are e.g. merely connected to adjacent clusters. In order to communicate to non-neighbouring clusters several inter-cluster copy operation are needed. E.g. the communication between cluster A and cluster C takes place by copying the data from cluster A to cluster B, and then copying the data from cluster B to cluster C. The copy operations are scheduled statically by the complier and executed by the switches of the cluster, wherein the data can only be moved from one cluster to the next within one cycle. Therefore, the latency of the communication between neighbouring and non-neighbouring clusters will be different and will depend on the actual distance between these clusters, resulting in a non-uniform inter-cluster latency. Although the wiring complexity will be decreased, problems for programming the processor will increase, since the compilation of the such an ICC scheme is more complex then the compilation of a clustered VLIW architecture. The main difficulties during compiling is the scheduling of ICC paths and avoiding dead-lock.

Yet another ICC scheme is the global bus connectivity. The clusters are fully connected to each other via a bus, while requiring much less hardware resources compared to the above ICC with a full point-to-point connectivity topology. Additionally, this scheme allows a value multicast, i.e. the same value can be send to several clusters at the same time or in other words several clusters can get the same value by reading the bus at the same time. The scheme is furthermore based on statical scheduling; hence neither an arbiter nor any control signals are necessary. Since the bus constitutes a shared resource it is only possible to perform one transfer per cycle limiting the communication bandwidth as being very low. Moreover, the latency of the ICC will increase due to the propagation delay of the bus. The latency will further increase with increasing numbers of clusters limiting the scalability of the processor with such an ICC scheme. Consequently, the clock frequency may be limited by connecting distant clusters like clusters A and D via a central global bus.

In another ICC communication scheme local busses are used. This ICC scheme is the socalled ReMove architecture and is a partially connected bus-based communication scheme. For more information about such an architecture please refer to S. Roos, H. Corporaal, R. Lamberts, “Clustering on the Move”, 4^{th} International Conference on Massively Parallel Computing System”, April 2002, Ischia, Italy. The local busses merely connect a certain amount of clusters but not all at one time, e.g. clusters A to C are connected to one local bus and clusters B to D are connected to a second local bus. The disadvantage of this scheme is that it is harder to program, because a complier with a more complex scheduling is required to avoid dead-lock. E.g. if a value is to be send from cluster A to cluster D, it can not be directly send within one cycle but at least two cycles are needed.

Accordingly, the advantages and disadvantages of the known ICC schemes can be summarised as follows. The point-to-point topology has a high bandwidth but the complexity of the wiring increases with the square of the number of clusters. Furthermore, a multicast, i.e. sending a value to several other clusters, is not possible. On the other hand, the bus topology has a lower complexity, since the complexity linearly increases with the number of clusters, and allows multicast, but has a lower bandwidth. The ICC schemes can either be fully-connected or partially connected. A fully-connected scheme has a higher bandwidth and a lower software complexity, but a higher wiring complexity is present and it is less scalable. A partially-connected scheme unites good scalability with lower hardware complexity but has a lower bandwidth and a higher software complexity.

It is therefore an object of the invention to improve the latency problems of an ICC scheme for a clustered ILP processor.

This object is solved by a clustered Instruction Level Parallelism processor according to claim 1.

The basic idea of the invention is to provide a clustered ILP processor based on a fully-connected inter-cluster network with a non-uniform latency.

According to the invention, a clustered instruction Level Parallelism processor is provided. Said processor comprises a plurality of clusters A, B, C, D each comprising at least one register file RF and at least one functional unit FU, wherein said clusters A, B, C, D are fully-connected to each other; and wherein the latency of the connections between said clusters A, B, C, D depends on the distance between said clusters A, B, C, D.

Even for the communication of distant or remote clusters a direct point-to-point connection is provided, so that a fully dead-lock free ICC network is provided. Furthermore, by providing an ICC network with non-uniform latency, a deeper pipelining of the connections between remote or distant clusters is achieved.

According to an aspect of the invention, the clusters A, B, C, D may be connected to each other via a point-to-point connection or via a bus connection 100, allowing a greater freedom during the design of the processor.

According to a preferred aspect of the invention, said bus connection 100 comprises a plurality of bus segments 100a, 100b, 100c. Said processor further comprises switching means 200, which are arranged between adjacent bus segments 100a, 100b, 100c, and which are used for connecting or disconnecting adjacent bus segments 100a, 100b, 100c.

By splitting the bus 100 into different segments 100a, 100b, 100c the latency of the bus within one bus segment 100a, 100b, 100c is improved. Although the overall latency of the total bus, i.e. all switches closed 200, is nonetheless linearly increasing with the number of clusters, data moves between local or adjacent clusters can have lower latencies than moves over multiple bus segments, i.e. over several switches 200a, 200b. A slow down of local communication, i.e. between neighbouring clusters, due to global interconnect requirements of the bus ICC can be avoided by opening switches 200, so that shorter busses, i.e. bus segments 100a, 100b, 100c, with lower latencies can be achieved. Furthermore, incorporating the switches is cheap and easy to implement, while increasing the available bandwidth of the bus and reducing latency problems caused by a long bus without giving up a fully-connected ICC.

The invention will now be described in more detail with reference to the drawing, in which:

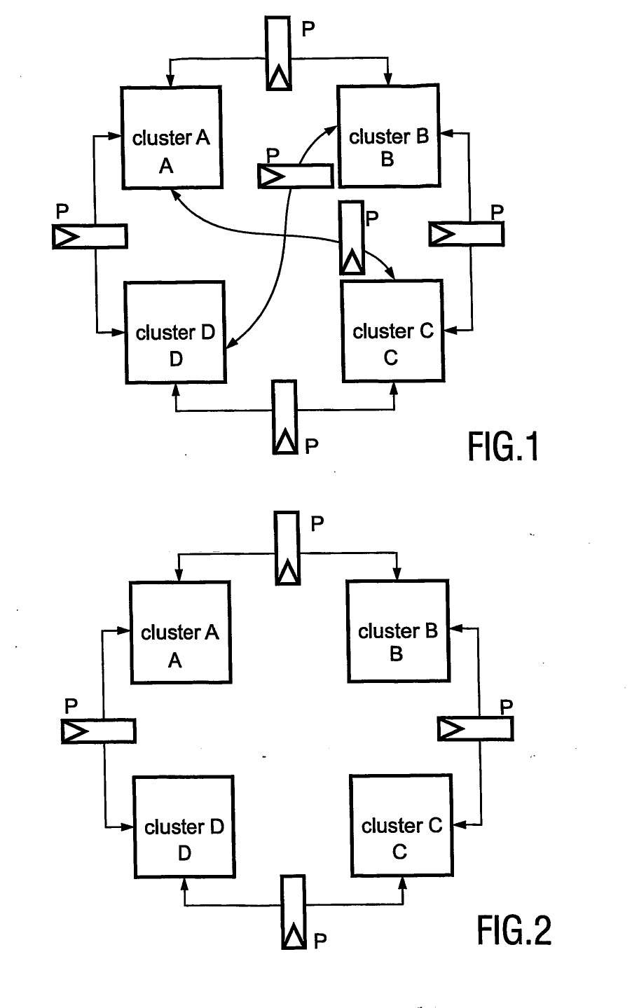

FIG. 1 shows a clustered VLIW architecture;

FIG. 2 shows a RAW-like architecture;

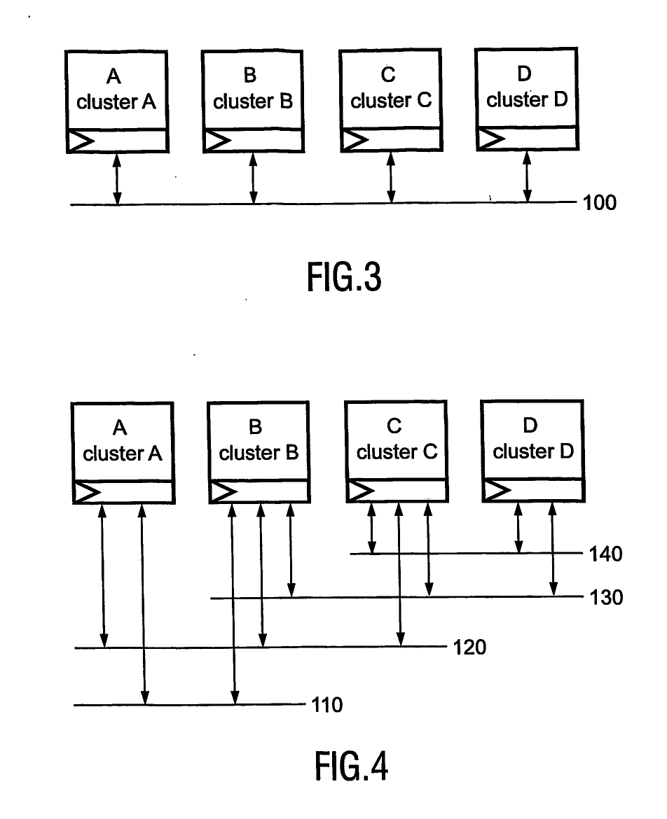

FIG. 3 shows a bus based clustered architecture;

FIG. 4 shows a ReMove architecture;

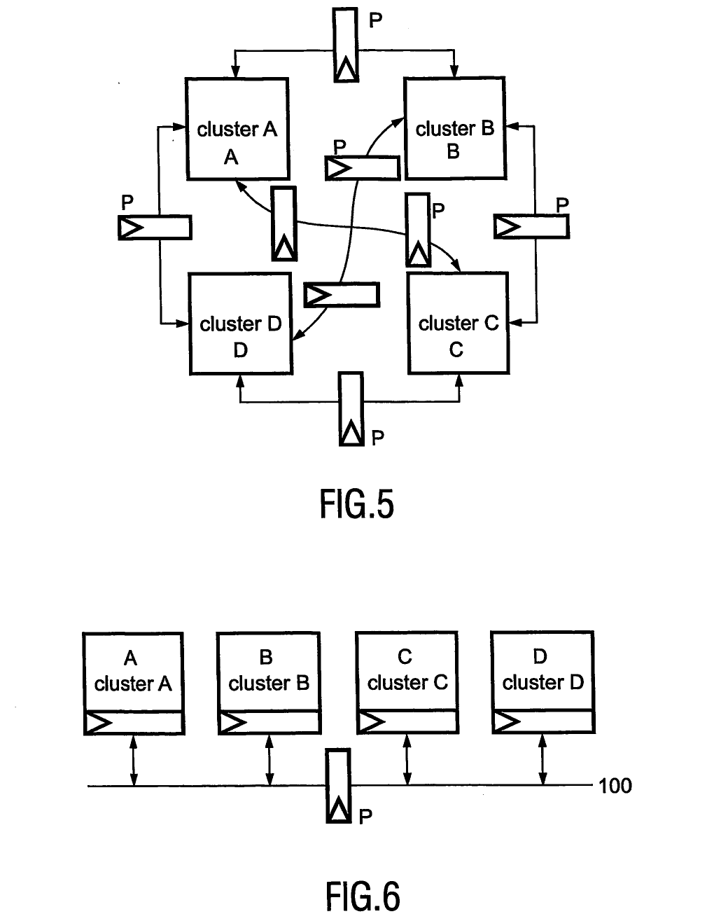

FIG. 5 shows a point-to-point clustered VLIW architecture according to a first embodiment;

FIG. 6 shows a bus based clustered VLIW architecture according to a second embodiment;

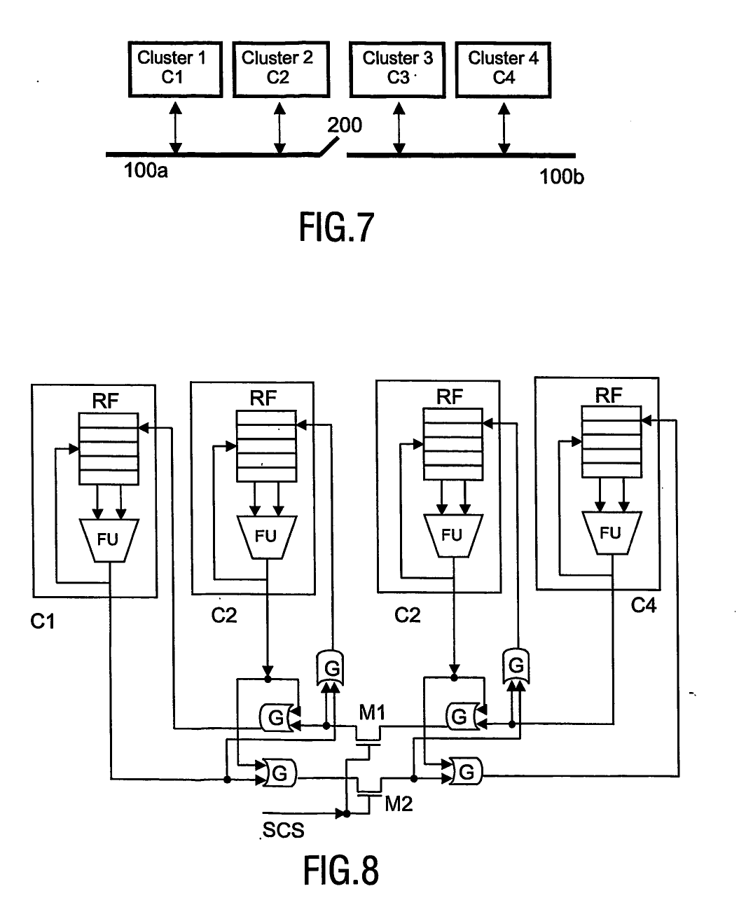

FIG. 7 shows an ICC scheme via a segmented bus according to a third embodiment; and

FIG. 8 shows an ICC scheme via a segmented bus according to a fourth embodiment; and

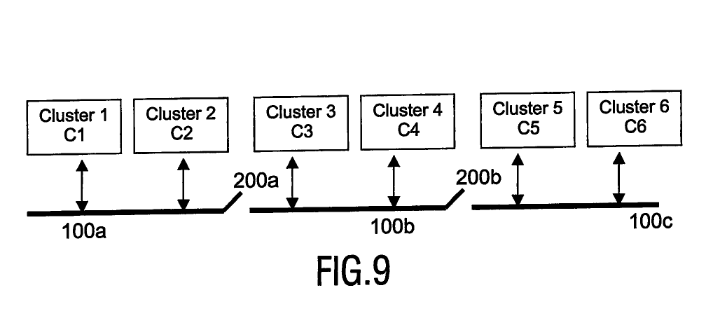

FIG. 9 shows an ICC scheme via a segmented bus according to a fifth embodiment.

In FIG. 1 a clustered VLIW architecture with a full point-to-point connectivity topology is shown. The architecture includes four clusters, namely clusters A, B, C and D, which are fully connected to each other. Accordingly, there is always a dedicated direct connection present between any two clusters. The latency of an inter-cluster transfer of data is always the same for every inter-cluster connection independent of the actual distance between the clusters on the chip. The actual distance on the chip between the clusters A and C, and clusters B and D is considered to be longer than the distance between the clusters A and D, A and B, B and C, as well as C and D. Furthermore, pipeline registers P are arranged between each two clusters.

In FIG. 2 a possible further partially connected networks for point-to-point ICC is shown. One example of such ICC scheme is the so-called RAW architecture as mentioned above. Here, the clusters A, B, C, D are not connected to all other clusters (fully connected) but are e.g. merely connected to adjacent clusters. In order to communicate to non-neighbouring clusters A, B, C, D several inter-cluster copy operation are needed. E.g. the communication between cluster A and cluster C takes place by copying the data from cluster A to cluster B, and then copying the data from cluster B to cluster C. The copy operations are scheduled statically by the complier and executed by the switches of the cluster, wherein the data can only be moved from one cluster to the next within one cycle. Therefore, the latency of the cominunication between neighbouring and non-neighbouring clusters will be different and will depend on the actual distance between these clusters, resulting in a non-uniform inter-cluster latency.

Yet another ICC scheme is the global bus connectivity as shown in FIG. 3. The clusters A, B, C, D are fully connected to each other via a bus 100, while requiring much less hardware resources compared to the ICC scheme as shown in FIG. 1. Additionally, this scheme allows a value multicast, i.e. the same value can be send to several clusters A, B, C, D at the same time or in other words several clusters can get the same value by reading the bus at the same time.

In another ICC communication scheme local busses are used as shown in FIG. 4. This ICC scheme is the above mentioned ReMove architecture and is a partially connected bus-based communication scheme. The local busses 110, 120, 130, 140, merely connect a certain amount of clusters A, B, C, D but not all at one time, e.g. clusters A to C are connected to one local bus 120 and clusters B to D are connected to a second local bus 130.

FIG. 5 shows a point-to-point clustered VLIW architecture according to a first embodiment of the invention This architecture is quite similar to the architecture of a clustered VLIW architecture according to FIG. 1. It includes four synchronously run clusters A, B, C and D, which are fully connected to each other via a direct point-to-point connection. Accordingly, there is always a dedicated direct connection present between any two clusters, so that a dead-lock free ICC is provided. The actual distance on the chip between the clusters A and C, and clusters B and D is considered to be longer than the distance between the clusters A and D, A and B, B and C, as well as C and D. Furthermore, one pipeline register P is arranged between the clusters A and B; B and C; C and D and; D and A, while two pipeline registers P are arranged between the remote clusters A and C as well between the remote clusters B and D. Accordingly, the number of pipeline registers P can be proportional to or dependent on the distance between the respective clusters.

The architecture according to the first embodiment may be called a super-cluster VLIW architecture, namely a clustered VLIW architecture with a fully connected non-uniform latency inter-cluster network. The scalability of this architecture lies between those of the clustered VLIW architecture as shown in FIG. 1 and the RAW-like architecture as shown in FIG. 2. In particular, the latency of the ICC connections is not uniform, since it depends on the actual distance between the respective clusters on the final layout of the chip. Regarding this aspect the architecture of the present invention differs from the architecture of the prior art clustered VLIW architecture according to FIG. 1. This has the advantage, that wire delay problems are reduced by deeper pipelining inter-cluster connections between remote clusters. The advantages of the super-clustered VLIW architecture over the clustered VLIW architecture is that by providing the non-uniform latency the wire delay problems are improved. But on the other hand, the scheduling becomes more complex than for clustered VLIW architecture, since the complier has to schedule the ICC in a network with a non-uniform latency.

The architecture according to the present invention differs from the RAW-like architecture according to FIG. 2 in that it is a fully connected inter-cluster network, whereas the RAW-like architecture merely is based on a partially connected network, namely the clusters are only connected to neighbouring clusters. The advantages of the super-clustered VLIW architecture over the RAW architecture is that a compacter code can be provided, since no switching instructions are needed and a dead-lock cannot occur. But on the other hand, since the super-clustered VLIW architecture is fully connected, the hardware resources, like wiring, increase quadratically with the numbers of the clusters.

FIG. 6 shows a bus based clustered VLIW architecture according to a second embodiment of the invention. The architecture of the second embodiment is similar to those of the bus-based clustered VLIW architecture according to FIG. 3. Distant clusters, like cluster A and D, are connected to each other via a central or global bus 100. However, this will lead to a limitation of the clock frequency. This disadvantage can be overcome by providing a super-clustered VLIW architecture as described above according to the first embodiment. In particular, the bus 100 is pipelined, the latencies of inter-cluster communication is made non-uniform and dependent on the distance between the clusters.

E.g. if cluster A sends data to cluster B, this will require one cycle, while a data move between cluster A and the remote cluster D require two cycles since the data has to pass the additional pipeline register P arranged between the clusters B and D. However, the instruction scheduling of this bus based super-cluster VLIW architecture corresponds to the scheduling of the point-to-point based super-cluster VLIW architecture according to the first embodiment.

TABLE 1
Comparison of different VLIW approaches

| | | | | | Typical | |
|---|---|---|---|---|---|---|
| | Compiler | # intercluster | # pipeline | Intercluster | number of | |
| | complexity | wires | registers | network | clusters | ICC latency |
| VLIW | Low | | | | | 0 cycles |
| Clustered VLIW | Medium | N(N − 1) | N(N − 1) | Fully connected | 2-4 | Uniform |
| Super-clustered VLIW | Medium | N(N − 1) | >=N(N − 1) | Fully connected | 2-25 | Non-uniform |
| ReMove | High | Arbitrary | N | Partially connected | >2 | Non-uniform |
| RAW | High | 4 | 4 | Partially connected | >2 | Non-uniform |

As can be seen from Table 1, the choice of the particular architecture, namely VLIW, clustered VLIW, super-clustered VLIW, ReMove or RAW, will depend on the number of the required clusters for a particular application with N being the number of clusters. E.g. a multi-media application and a general purpose code is a rather irregular application and provides ILP rates of up to approximately 16 operations per instruction. If we use 2-4 functional units per cluster, since recent research showed that the number of clusters should not be to small, this will result in 4-8 clusters. Hence, a super-clustered VLIW architecture appears to be well fitted for these applications.

FIG. 7 shows an inter-cluster communication ICC scheme via a segmented bus according to a third embodiment. Said ICC scheme may be incorporated additionally into a super-clustered VLIW processor according to the second embodiment. The scheme comprises 4 clusters C1-C4 connected to each other via a bus 100 and one switch 200 segmenting the bus 100. When the switch 200 is open, one data move can be performed between cluster 1 C1 and cluster 2 C2 and/or another between cluster 3 C3 and cluster 4 C4 within one cycle. On the other hand, when the switch 200 is closed, data can be moved within one cycle from cluster 1 C1 or cluster 2 C2 to either cluster 3 C3 or cluster 4 C4.

Although the ICC scheme according to the third embodiment only shows a single bus 100, the principles of the invention can readily be applied to multi-bus ICC schemes and ICC schemes using local busses. Merely some switches need to be incorporated into the multi-bus or the local bus in order to achieve a split or segmented bus.

FIG. 8 shows a inter-cluster communication ICC scheme via a segmented bus according to a fourth embodiment, which is based on said third embodiment. Said ICC scheme may be incorporated additionally into a super-clustered VLIW processor according to the second embodiment. Here the clusters C1-C4 as well as the switch control is shown in more detail. Each cluster C1-C4 comprises a register file RF and a functional unit FU, and is connected to one bit bus 100 via an interface which is constituted of merely 3 OR gates G per bit. Alternatively, AND, NAND or NOR gates G can be used as interface. However, each cluster C1-C4 can obviously comprise more than one register file RF and one functional unit FU. The functional units FU may be specialised functional units dedicated to any bus operations. Furthermore, there may be several functional units writing to the bus.

The representation of the bypass logic of the register file is omitted, since it is not essential for the understanding of the split or segmented bus according to the invention. Although only one bit of the bus word is shown, it is obvious that the bus can have any desired word size. Moreover, the bus according to the second embodiment is implemented with two wires per bit. One wire is carrying the left to right value while the other wire carries the right to left value of the bus. However, other implementations of the bus are also possible.

The bus splitting switch 200 can be implemented with a few MOS transistors M1, M2 for each bus line.

The access control of the bus can be performed by the clusters C1-C4 by issuing a local_mov or a global_mov operation. The arguments of these operations are the source register and the target register. The local_mov operation merely uses a segment of the bus by opening the bus-splitting switch, while the global_mov uses the whole bus by closing the bus-splitting switch.

Alternatively, in order to allow multicast, the operation to move data may accept more than one target register, i.e. a list of target registers, belonging to different clusters C1-C4. This may also be implemented by a register/cluster mask in a one bit vector.

FIG. 9 shows a inter-cluster communication ICC scheme via a segmented bus according to a fifth embodiment of the invention, which is based on said third embodiment. Said ICC scheme may be incorporated additionally into a super-clustered VLIW processor according to the second embodiment. FIG. 7 depicts six clusters C1-C6, a bus 100 with three segments 100a, 100b, 100c and two switches 200a, 200b, i.e. two clusters are associated to each bus segment. Obviously, the number of clusters, switches and bus segments may vary from this example. The clusters, the interface of the clusters and the bus as well as the switches can be embodied as described in the fourth embodiment with reference to FIG. 8. In the fifth embodiment the switches are considered to be closed by default.

The bus access can be performed by the clusters either by a send operation or a receive operation. In those cases that a cluster needs to send data, i.e. perform a data move, to another cluster via the bus, said cluster performs a send operation, wherein said send operation has two arguments, namely the source register and the sending direction, i.e. the direction to which the data is to be sent. The sending direction can be ‘left’ or ‘right’, and to provide for multicast it can also be ‘all’, i.e. ‘left’ and ‘right’.

For example, if cluster 3 C3 needs to move data to cluster 1 C1, it will issue a send operation with a source register, i.e. one of its registers where the data to be moved is stored, and a sending direction indicating the direction to which the data is to be moved as arguments. Here, the sending direction is left. Therefore, the switch 200b between cluster 4 C4 and cluster 5 C5 will be opened, since the bus segment 100c with the clusters 5 and 6 C5, C6 is not required for this data move. Or in other more general words, when the cluster issues a send operation, the switch, which is arranged closest on the opposite side of the sending direction, is opened, whereby the usage of the bus is limited to only those segments which are actually required to perform the data move, i.e. those segments between the sending and the receiving cluster.

If the cluster 3 C3 needs to send the same data to clusters 1 and 6 C1, C6, i.e. a multicast, then the sending direction will be ‘all’. Therefore, all switches between the cluster 3 C3 and the cluster 1 C1 as well as all switches between the clusters 3 and 6 C3, C6 will remain closed.

According to a further example, if cluster 3 C3 needs to receive data from cluster 1 C1, it will issue a receive operation with a destination register, i.e. one of its registers where the received data is to be stored, and a receiving direction indicating the direction from where the data is to be received as arguments. Here, the receiving direction is left. Therefore, the switch between cluster 4 and cluster 5 C4, C5 will be opened, since the bus segment with the clusters 5 and 6 C5, C6 is not required for this data move. Or in other more general words, when the cluster issues a receive operation, the switch, which is arranged closest on the opposite side of the receiving direction, is opened, whereby the usage of the bus is limited to only those segments which are actually required to perform the data move, i.e. those segments between the sending and the receiving cluster.

For the provision of multicast the receiving direction may also be unspecified. Therefore, all switches will remain closed.

According to a sixth embodiment, which is based on the third embodiment, the switches do not have any default state. Furthermore, a switch configuration word is provided for programming the switches 200. Said switch configuration word determines which switches 200 are open and which ones are closed. It may be issued in each cycle as with normal operation, like a sending/receiving operation. Therefore, the bus access is performed by a sending/receiving operation and a switch configuration word in contrast to a bus access by a sending/receiving operation with the sending/receiving direction as argument as described according to the fifth embodiment. Said ICC scheme may be incorporated additionally into a super-clustered VLIW processor according to the second embodiment.

1. A clustered Instruction Level Parallelism processor, comprising a plurality of clusters each comprising at least one register file and at least one functional unit;
wherein said clusters are fully-connected to each other; and
wherein the latency of the connections between said clusters is dependent on the distance between said clusters.

2. Processor according to claim 1, comprising at least one pipeline register arranged between each two clusters.

3. Processor according to claim 2, wherein the number of pipeline registers between two clusters depend on the distance between said two clusters.

4. Processor according to claim 1, wherein the clusters are connected to each other via a point-to-point connection.

5. Processor according to claim 1, wherein the clusters are connected to each other via a bus connection.

6. Processor according to claim 5, wherein
said bus connection is adapted for connecting said clusters and comprises a plurality of bus segments, and
said processor further comprising:
switching means, arranged between adjacent bus segments, for connecting or disconnecting adjacent bus segments.

7. Processor according to claim 6, wherein said bus connection is a multi-bus comprising at least two busses.
